(19) United States
(12) Patent Application Publication
(10) Pub. No.: US 2014/0114470 A1
(43) Pub. Date: Apr. 24, 2014

(54) METHODS AND SYSTEMS FOR IMPROVING EFFICIENCY OF PHARMACY PRACTICE AND REDUCING THE INCIDENCE OF MEDICATION ERRORS

(71) Applicant: Rashid Pharmacy, P.L.C., Fort Madison, IA (US)

(72) Inventor: Joseph G. Rashid, Wever, IA (US)

(73) Assignee: Rashid Pharmacy, P.L.C., Fort Madison, IA (US)

(21) Appl. No.: 14/062,574

(22) Filed: Oct. 24, 2013

Related U.S. Application Data
(60) Provisional application No. 61/717,822, filed on Oct. 24, 2012.

(51) Int. Cl. G06F 19/00

(52) U.S. Cl. CPC G06F 19/3462
USPC 700/235

(57) ABSTRACT

The inventions disclosed herein generally relate to methods and systems for dispensing ordered medication as well as methods and systems for conveniently and rapidly providing patients with information regarding their prescribed medications. The present inventions improve the productivity and efficiency of pharmacy department personnel and reduce the incidence of medication errors.

### RELATED APPLICATION

This application claims the benefit of U.S. Provisional Application No. 61/717,822, filed Oct. 24, 2012. The entire teachings of the above application are incorporated herein by reference.

### FIELD OF THE INVENTION

The inventions disclosed herein relate to the field of pharmacy practice. Disclosed are methods and systems for dispensing ordered medication as well as methods and systems for conveniently and rapidly providing patients with information regarding their ordered or prescribed medications. The present inventions improve the productivity and efficiency of pharmacy department personnel and reduce the incidence of medication errors.

### BACKGROUND OF THE INVENTION

Existing methods, systems and processes for filling and verifying prescriptions and medication orders require multiple interrelated steps, many of which are plagued by inefficiencies. Traditional methods and systems for filling and verifying medication orders generally involve the delivery or communication of a medication order to pharmacy personnel. The medication order is frequently placed in a queue of medication orders to be prepared and upon reaching the top of the queue the medication order is entered into the pharmacy records or systems (e.g., a computer system). The ordered medication is then prepared, generally by taking the ordered medication from a stock container, placing the appropriate quantity of such ordered medication in another container, and appropriately labeling such other container.

Prior to dispensing the ordered medication to a patient, a pharmacist verifies that the medication order has been accurately entered into the pharmacy records or system, verifies that the medication order has been accurately filled and generally conducts a retrospective and/or prospective review to determine the presence of any contraindications, interactions or other restrictions. Frequently, the step of verifying that the medication order has been accurately filled involves a comparison of the contents of a stock container to the contents of the container into which the ordered medication was disposed. Prior to dispensing the medication, the patient is generally counseled by the pharmacist regarding the ordered medication, its use and any relevant warnings. Frequently, such patients may also receive printed instructional or educational materials regarding such ordered medication and the use thereof.

The nature and the number of the steps involved in the dispensing of ordered medications adversely impact the rate at which medication orders are inaccurately filled by pharmacy personnel and incorrectly dispensed to patients. Similarly, the physical distribution of printed instructional or educational materials, which are often highly technical in nature, may adequately address patients' questions or concerns regarding an ordered medication, but are often discarded by patients without having been reviewed, thereby increasing the risk that such medication is incorrectly used by the patient.

Inaccurately or incorrectly filled, dispensed or used medications present a serious threat to the safety of patients and have the potential to cause severe injury or even death in certain instances. One of the first reports calling attention to the incidence of medication errors was published by the Institute of Medicine and estimated errors in patient care accounted for approximately 44,000 to 98,000 patient deaths annually and in excess of one million patient injuries annually (see, Kohn L T, et al., eds. Committee on Quality of Health Care in America, Institute of Medicine. To Err is Human: Building a Safer Health System. Washington, D.C.: National Academy Press; 1999.) The same institute of Medicine publication reported that 7,000 Americans die annually from medication errors alone. In 2006, the Institute of Medicine published an updated report, reiterating the problem of medication errors and finding that medication naming, labeling, and packaging accounted for 33% of medication errors and 30% of fatalities (see, Aspden P, et al., eds. Preventing Medication Errors. Washington, D.C.: National Academy Press; 2006.) Such deaths are largely preventable, further underscoring the importance of implementing strategies directed to the minimization of medication errors.

Factors further contributing to the high rates of medication errors include the aging of the population, increasing volume of prescription medications, reduced availability of pharmacy support personnel and longer pharmacy hours. Other factors contributing to the incidence of medication errors include the lack of coordination among a patient's caregivers and healthcare providers, failures on the part of clinicians and pharmacists to properly educate patients about their prescribed medications and a failure on the part of patients to recognize and/or report suspected adverse reactions or medication errors.

While efforts to mitigate the incidence of medication errors are underway (e.g., migrating to electronically transmitted prescriptions) further developments are still needed. Particularly needed are strategies that facilitate the accurate filling and dispensing of ordered medications and novel methods, systems and products that facilitate a determination that prescriptions for ordered medications have been accurately dispensed. Also needed are novel methods and systems to help ensure that the patients to whom such ordered medications are dispensed understand the nature of such medications and are fully informed regarding their proper use, storage, handling, contraindications and potential adverse effects. Also needed are novel methods and systems that may be used by patients to inform and educate themselves about their ordered or prescribed medication.

### SUMMARY OF THE INVENTION

Disclosed herein are novel methods and systems of dispensing and verifying an ordered or prescribed medication. In certain embodiments, such methods and systems may be employed to improve the accuracy with which medication orders are filled. Also disclosed are certain methods and systems that may be employed to conveniently and rapidly provide a patient with relevant educational or instructional information regarding an ordered medication. For example, in certain embodiments, such methods and systems comprise the use of one or more codes that facilitate the retrieval of information regarding ordered or prescribed medications by patients and their caregivers. The inventions disclosed herein further provide means of reducing the incidence of medication errors (e.g., medication dispensing errors) as well as means of efficiently and accurately dispensing ordered medications.

In one embodiment, disclosed herein are methods and systems of dispensing an ordered medication (e.g., a prescription medication ordered by a prescriber). Such methods generally comprise the steps of receiving an order for the medication (e.g., receiving a medication order from the patient or prescribing clinician), accessing a database (e.g., electronically accessing a database using a computer) and retrieving information from such accessed database (e.g., electronically retrieving information corresponding to the ordered medication from the accessed database using a computer). In certain embodiments, the accessed database comprises records of information that may be used to identify or to determine the identity of the ordered medication. For example, the electronic database may comprise records of information corresponding to the physical characteristics (e.g., size, shape and/or color) of the ordered medication. In certain embodiments, the information retrieved from the database comprises identifying information that corresponds to the ordered medication. The information accessed from the database may be recorded, organized or categorized by any means, including for example, by the medication's National Drug Code (NDC) number, name, manufacturer, distributor, dosage and combinations thereof.

The methods disclosed herein further comprise steps of providing a label (e.g., a self-adhesive label) and a container (e.g., an amber vial, a bottle, a package, a box, unit doses or a metered dose inhaler), wherein the label comprises the retrieved identifying information corresponding to the ordered medication, and wherein the container is suitable to receive the ordered medication. In certain aspects, the label is provided after the medication order has been correctly entered into the pharmacy's system (e.g., the pharmacy's computer system) and such entry verified for example, by a pharmacist. The label may be affixed to the container (e.g., a bottle or an amber vial) and the ordered medication disposed in the container. Prior to dispensing the ordered medication, the retrieved identifying information on the label is compared to the medication previously disposed in the container (e.g., compared by a pharmacist). If the retrieved identifying information on the label corresponds to the ordered medication disposed in the container, the ordered medication may be dispensed to the patient. Conversely, if the retrieved identifying information on the label does not correspond to the ordered medication disposed in the container, the ordered medication should not be dispensed to the patient. In such instances, the medication order should be re-evaluated and any identified deficiencies corrected.

Also disclosed herein are methods and systems for verifying that a medication order has been accurately or correctly filled (e.g., verifying that a medication order has been accurately filled by a pharmacist, technician or other pharmacy personnel). Such methods and systems may be relied upon by the pharmacist as part of the verification procedure or alternatively by the patient or a caregiver to confirm that the ordered medication was accurately dispensed. The methods and systems generally comprise a step of receiving an order for the medication (e.g., from the patient or directly from the prescribing clinician) and accessing a database (e.g., electronically accessing a database) that comprises records of identifying information. In certain embodiments, a record of the identifying information corresponding to the ordered medication (e.g., physical characteristics) is retrieved from the database and such identifying information is placed or otherwise disposed (e.g., by printing) on a label.

In certain embodiments, the label further comprises a code (e.g., a barcode) for retrieving a monograph corresponding to the ordered medication. For example, the monograph may be retrieved from a second database (e.g., a website, an online database or directory) using an electronic device such as a computer or other mobile device. The code for retrieving the monograph may comprise any number of art-recognized codes or means, including a barcode, a QRCode, an internet address and/or a phone number. In some embodiments, the retrieved monograph s customized for the patient, based on factors such as, for example, the patient's age, co-morbidities, allergies, other medications, family or social history, immunization status and combinations thereof. In such embodiments, the availability of a customized monograph may be used to communicate patient- or disease state-specific information to the patient, thereby reducing reliance on the pharmacist and pharmacy staff to respond to routine questions and increasing efficiency and/or productivity.

The methods and systems disclosed herein comprise steps of providing a container (e.g., a vial or a bottle) suitable to receive the ordered medication. A suitable container may be selected based on a number of factors which include the quantity or volume of the ordered medication to be dispensed. In certain embodiments, the ordered medication is commercially available in a container suitable to receive the ordered medication. For example, certain ordered medications such as metered dose inhalers, oral contraceptives or insulin may be commercially available in packaging that is suitable to receive the ordered medication and onto which the labels disclosed herein may be readily affixed.

The labels disclosed herein may be affixed to the container and the contents of the container verified (e.g., by a pharmacist) to confirm whether or not the retrieved identifying information on such label corresponds to the ordered medication disposed in the container. In certain embodiments, if the retrieved identifying information on the label corresponds to the ordered medication disposed in the container, the medication order has been correctly filled. Conversely, if the medication disposed in the container does not correspond to the contents of the container, the medication order has been incorrectly filled and further action may be necessary before dispensing the medication to the patient.

Contemplated identifying information that may be retrieved (e.g., from one or more databases) in accordance with the teachings of the present invention include, for example, a description of the physical characteristics of the ordered medication. In some embodiments, the retrieved identifying information comprises an image (e.g., a high- or low-resolution color image of the ordered medication). In other embodiments, the retrieved identifying information comprises a National Drug Code (NDC) number. In yet other embodiments, the retrieved identifying information further comprises one or more identifiers of the ordered medication, wherein the identifiers are selected from the group consisting of size, shape, color, markings, dosage form and combinations thereof.

In certain embodiments, the labels disclosed herein consist of identifying information. In certain other embodiments, the labels disclosed herein may further comprise additional information. For example, the labels (e.g., self-adhesive labels) may additionally comprise information selected from the group consisting of a patient's name, a patient's address, a prescriber's name, the name of the ordered medication, an expiration date of the ordered medication, the number of refills remaining, a phone number and combinations thereof. In certain embodiments, at least two labels are affixed to the container. For example, a first label comprising the identifying information (e.g., the physical characteristics of the ordered medication and a code for retrieving a monograph) may be affixed to a container having a second label (e.g., a second label comprising the name of the patient, the name of the ordered medication and instructions for using such ordered medication). In certain embodiments, the present inventions relate to a single label comprising a means or code for retrieving a monograph (e.g., a prescription label comprising a bar code that may be used to access a monograph corresponding to the ordered medication).

The above-discussed and many other features and attendant advantages of the present invention will become better understood by reference to the following detailed description of the invention when taken in conjunction with the accompanying examples. The various embodiments described herein are complimentary and can be combined or used together in a manner understood by the skilled person in view of the teachings contained herein.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a flowchart depicting an exemplary method or system of dispensing a medication in accordance with an embodiment of the present invention.

FIG. 2 is a flowchart illustrating an exemplary method or system of verifying that a medication order has been accurately dispensed or filled in accordance with an embodiment of the present invention.

FIG. 3 is a flowchart depicting an exemplary method or system of verifying that a medication has been accurately dispensed or filled in accordance with an embodiment of the present invention.

FIG. 4 depicts an exemplary label in accordance with one embodiment of the present invention. As depicted in FIG. 4, the label comprises identifying information in the form of the name, manufacturer and dosage form of the medication, as well as a color image and description thereof.

FIG. 5 illustrates an exemplary label in accordance with one embodiment of the present invention. As illustrated in FIG. 5, the label comprises identifying information in the form of the name, manufacturer and dosage form of the medication, as well as a color image and description thereof. The label further comprises a QRCode, which can be accessed using an electronic device (e.g., a computer, scanner or mobile phone) as a means for retrieving a monograph corresponding to the medication.

FIG. 6 depicts an exemplary prescription label in accordance with one embodiment of the present invention. As illustrated, the prescription label comprises information identifying the name of the medication, instructions for its use, the prescriber, quantity dispensed, remaining refills and pharmacy information. The label further comprises identifying information in the form of an image of the medication.

FIG. 7 depicts an exemplary prescription label in accordance with one embodiment of the present invention. As illustrated, the prescription label comprises information identifying the name of the medication, instructions for its use, the prescriber, quantity dispensed, remaining refills and pharmacy information. The label further comprises a QRCode, which can be accessed using an electronic device (e.g., a computer, scanner or mobile phone) as a means for retrieving a monograph corresponding to the medication.

FIG. 8 illustrates an exemplary prescription label in accordance with one embodiment of the present invention. As illustrated, the prescription label comprises information identifying the name of the medication, instructions for its use, the prescriber, the quantity dispensed, the remaining refills and the pharmacy information. The label further comprises a barcode, which can be accessed using an electronic device (e.g., a computer, scanner or mobile phone) as a means for retrieving a monograph corresponding to the medication.

FIG. 9 depicts an exemplary label in accordance with one embodiment of the present invention. As depicted in FIG. 9, the label comprises identifying information in the form of the name, the general indication and a color image of the dispensed medication, in addition to a QRCode which can be accessed using an electronic device (e.g., a computer, scanner or mobile phone) as a means for retrieving a monograph corresponding to the medication.

FIG. 10 depicts an exemplary label in accordance with one embodiment of the present invention. As depicted in FIG. 10, the label comprises identifying information in the form of the name, the general indication, the maximum daily dose and a color image of the dispensed medication, in addition to a QRCode which can be accessed using an electronic device (e.g., a computer, scanner or mobile phone) as a means for retrieving a monograph corresponding to the medication.

### DETAILED DESCRIPTION OF THE INVENTION

Disclosed herein are methods and systems that may be used to improve the efficiency and productivity of pharmacy departments and their personnel, and in particular to improve the efficiency and productivity of such personnel involved in the preparation and/or dispensing of ordered medications. Such methods and systems further provide means of rapidly and conveniently communicating information to patients and their caregivers regarding the proper use and administration of an ordered medication. Furthermore, the present inventions advantageously reduce the incidence of medication dispensing errors and adverse reactions associated with the improper use or administration of medications.

The present inventions generally relate to methods and systems of dispensing ordered medications and for verifying that a prescription for an ordered medication has been accurately filled and/or dispensed. More particularly, the inventions relate to a labeling system and related methods that may be used to communicate certain information (e.g., identifying information and/or a monograph) regarding an ordered medication to one or more persons (e.g., a verifying pharmacist, a patient, a caregiver or to other healthcare providers). Such information communicated in accordance with the methods and systems disclosed herein may include certain identifying information that may be used to confirm that the dispensed medication corresponds to the medication ordered by the prescribing clinician. The present methods and systems may be used as a means of reducing the incidence of medication errors and improving the accurate fulfillment of medication orders by pharmacy department personnel.

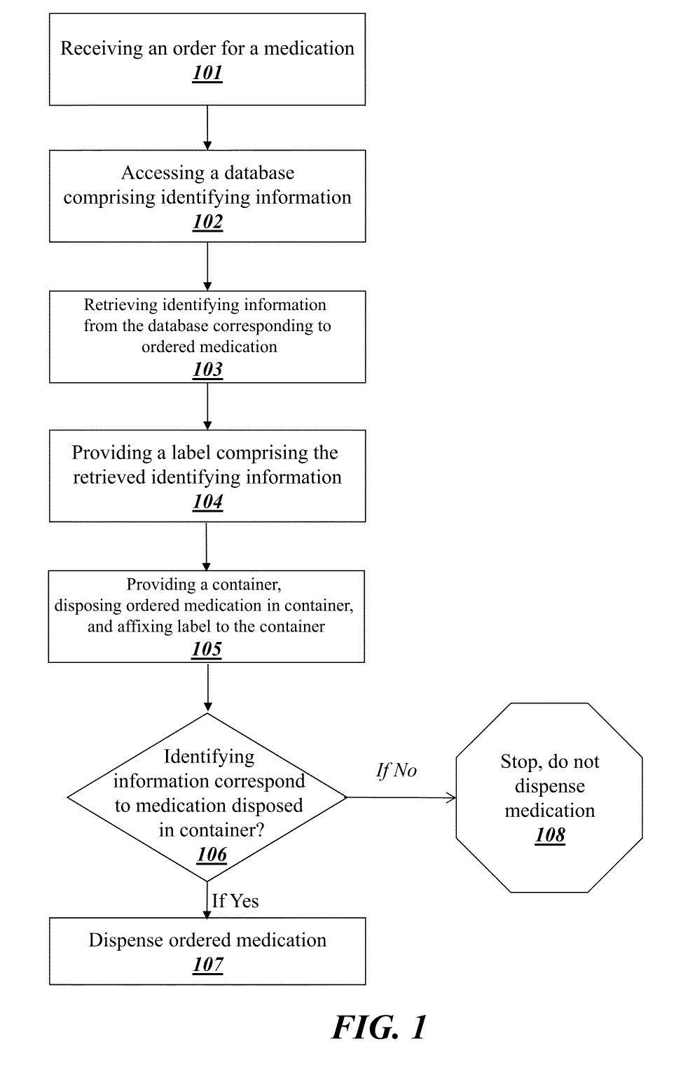

In certain embodiments, disclosed herein are methods and systems of dispensing an ordered medication (e.g., a prescription medication ordered by a prescriber or a refill requested by a patient). For example, with reference to FIG. 1, in certain embodiments, the present inventions comprise a step of receiving an order for a medication (101). Such a medication order may be received (e.g., physically or electronically received by pharmacy department personnel) from a prescribing clinician (e.g., a physician) or from the patient or patient caregiver (e.g., a medication refill request). Upon receipt of the medication order, a database comprising records of identifying information is accessed (102) (e.g., accessed by pharmacy department personnel) and the particular record comprising the identifying information corresponding to the ordered medication is retrieved from the database (103).

It should be noted that the phrases “medication order” and “order for medication” are used herein interchangeably to refer to a written, electronic or verbal order, prescription or request (e.g., by a prescribing clinician or patient), for the filling, preparation, dispensation and/or administration of a medicine or other treatment to a patient. For the purposes hereof, the phrases “medication order” and “order for medication” include both new or original requests for medications as well as requests to refill medications.

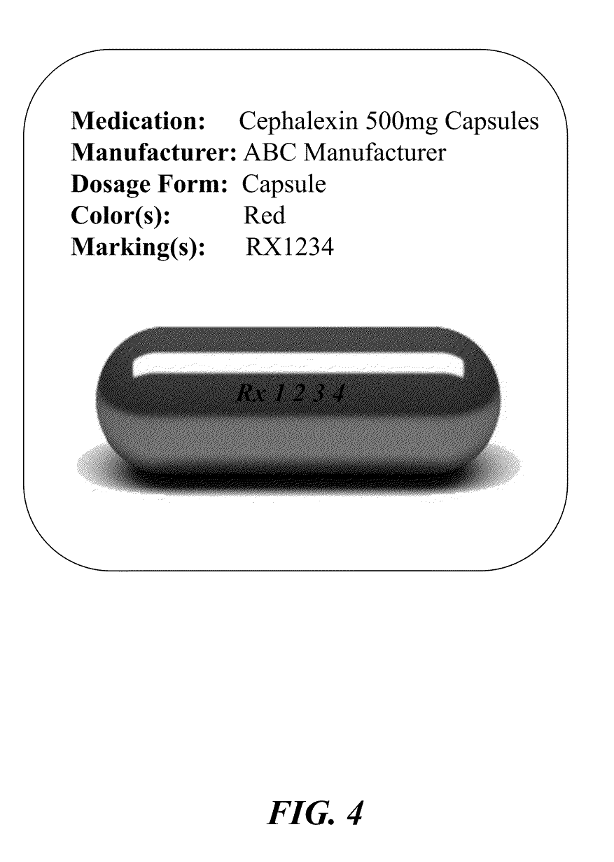

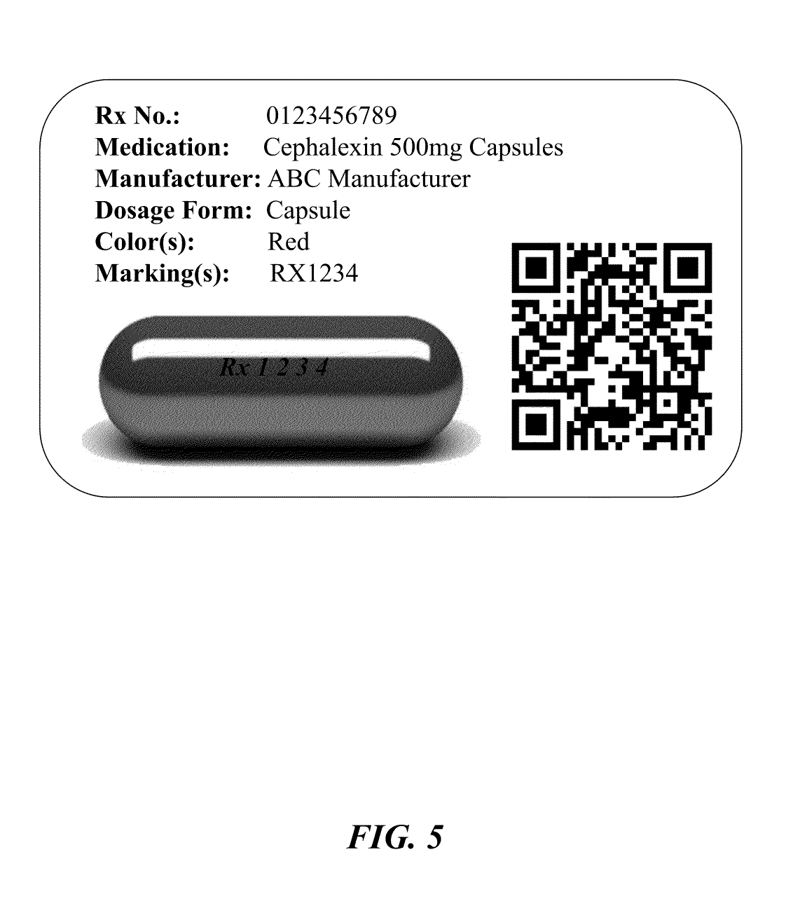

As used herein, the phrase “identifying information” refers to any information that may be relied upon to determine the identity or source of an ordered or dispensed medication. Identifying information that may be retrieved in accordance with the teachings of the present invention include, for example, a description of the physical characteristics of the ordered or dispensed medication. For example, in some embodiments, the identifying information retrieved from one or more databases comprises an image (e.g., a high- or low-resolution color image) of the ordered medication printed on a label, as depicted in FIG. 4, In certain embodiments, the identifying information comprises a description of the dispensed medication printed on a label, as depicted in FIG. 5. In other embodiments, the retrieved identifying information comprises a National Drug Code (NDC) number. In yet other embodiments, the retrieved identifying information further comprises one or more identifiers of the ordered medication, wherein the identifiers are selected from the group consisting of size, shape, color, markings, dosage form of the ordered medication and combinations thereof. For example, the identifying information may comprise a brief description of the physical appearance of the dispensed medication, which may include, but not be limited to, the size, shape, color, dosage form, markings, imprints, flavor and/or scent of such dispensed medication.

Referring again to FIG. 1, upon retrieval of the identifying information (or of a record comprising such identifying information) corresponding to the ordered medication from a database, such identifying information (e.g., one or more images) may be printed, published or otherwise written on a provided label (104). Upon filling the medication order and disposing the ordered medication into a suitable container, the previously-provided label is attached or otherwise affixed to the container (105).

As used herein, the term “label” generally refers to any written or printed display of subject matter, such as identifying information or one or more codes that facilitate the retrieval of a monograph corresponding to the ordered medication. In accordance with the teachings of the present invention, such labels are intended to be affixed to a container into which a medication was or will be disposed or to such container's closure system, in each event using routine means known to those of skill in the art. In certain embodiments, the label is self-adhesive.

In certain instances, multiple labels may be affixed to the container. For example, a primary label comprising any combination of the name of the ordered medication, directions of use, dose, prescriber and/or patient name, pharmacy name and phone number, prescription number, number of remaining refills and/or expiration dating may be affixed to the container. In certain embodiments, such a primary label may further comprise identifying information and/or a code for retrieving a monograph corresponding to the ordered medication. Alternatively, in certain embodiments, one or more of the identifying information and/or the code for retrieving a monograph corresponding to the ordered medication may be included on a secondary, tertiary or auxiliary label that can be affixed to the container (e.g., affixed onto the container closure). Still in other embodiments, the present invention involves the use of a single label that can be affixed to the container. For example, a primary label may further comprise a code or means for retrieving a monograph corresponding to the ordered medication (e.g., upon scanning such a code using an electronic device).

The methods and systems disclosed herein generally comprise a step of providing a container (e.g., a vial, bottle, bag or box) suitable to receive the ordered medication (105). As used herein, the term “container” generally refers to any article or receptacle capable of receiving an ordered medication or into which an ordered medication may be disposed. For the purposes hereof, a container includes any closures or closure systems that may form part of or otherwise be associated with the container. For example, in certain aspects the container comprises a child-resistant or safety system or safety cap onto which one or more labels may be affixed. In certain embodiments, the ordered medication is commercially available in a container suitable to receive the ordered medication. For example, certain ordered medications, such as metered dose inhalers, oral contraceptives or insulin, may be commercially available in packaging that is suitable to receive the ordered medication and onto which the labels disclosed herein may be readily affixed.

Referring again to FIG. 1, the methods and systems disclosed herein may further comprise a step of determining whether the contents of the container (e.g., medication previously disposed in the container) correspond with, match or otherwise resemble the identifying information present on the label affixed to such container (106). For example, after a medication order has been processed and filled by pharmacy personnel (e.g., a certified pharmacy technician), the medication order, the container containing the ordered medication and any other necessary information or documentation may be presented to a pharmacist to verify that such medication order was appropriately and accurately processed and filled. In certain embodiments, the medication disposed in the container is compared to the identifying information affixed to such container (106). If such medication corresponds to or otherwise matches the identifying information affixed to the container, the ordered medication has been accurately filled and may be dispensed (107) (e.g., dispensed to the patient). In those embodiments where the medication does not correspond to or does not otherwise match the identifying information affixed to the container, the ordered medication may not have been correctly processed or accurately filled and the medication should not be dispensed (108). Rather, in such embodiments the incorrectly processed or inaccurately filled medication should be subjected to further analysis or processing to correct or resolve the identified deficiency prior to being dispensed.

As used herein with reference to one or more medications, the term “dispense” means to prepare and release or otherwise provide one or more medications (e.g., ordered medications) or the act of removing such medications from the pharmacy department, in each case for delivery to and/or use by the applicable patient. The term “medication” refers to any composition, compound or therapeutic that is the subject of a medication order and intended to be dispensed or otherwise administered to a patient, including but not limited to pharmaceuticals, medical foods, medical devices, dietary supplements and the like. In accordance with the teachings of the present inventions an ordered medication is dispensed to the applicable patient subsequent to the performance of a verification step performed by a pharmacist.

The terms “verify” and “verification”, as used herein generally refer to the process of determining whether a prescription order has been accurately entered into the pharmacy records or system and that the prescription order has been accurately filled (e.g., by determining that a medication disposed in a container corresponds to or otherwise matches the corresponding medication order). Such a verification process occurs prior to dispensing the ordered medication to a patient and generally comprises a counseling step, whereby the patient is counseled by the pharmacist regarding the ordered medication and its appropriate use. Such verification process may further comprise a determination that the medication order is appropriate, for example, by conducting a retrospective and/or prospective drug utilization review or evaluation of the patient and his or her records. In certain embodiments, the verification process is conducted by the pharmacist.

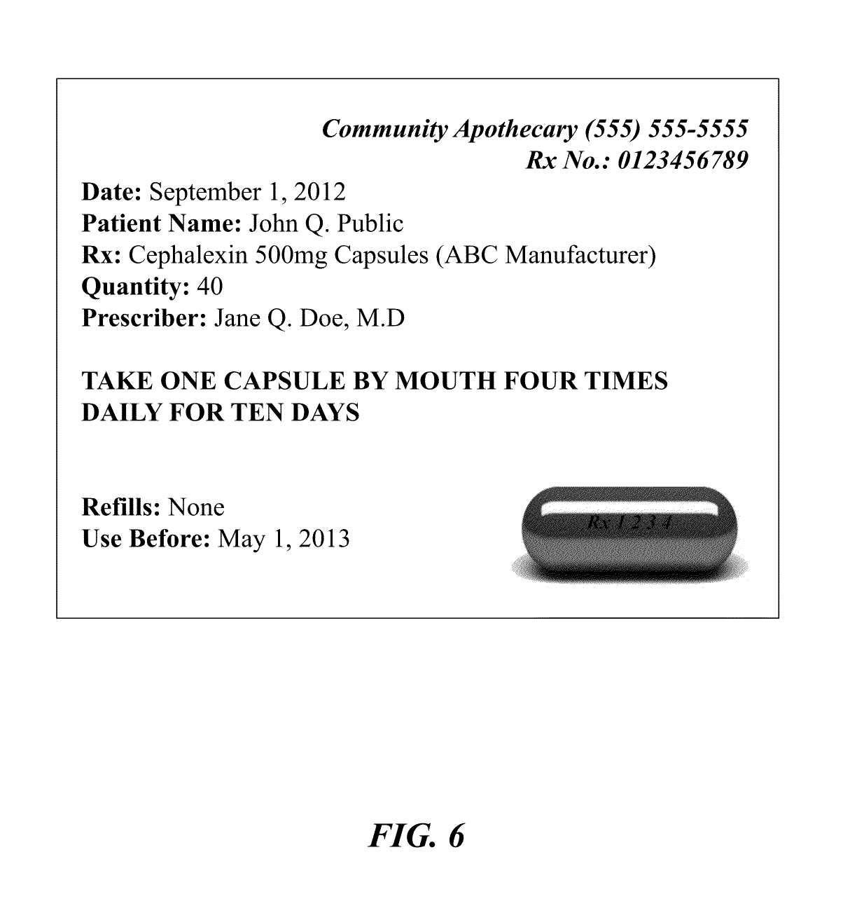

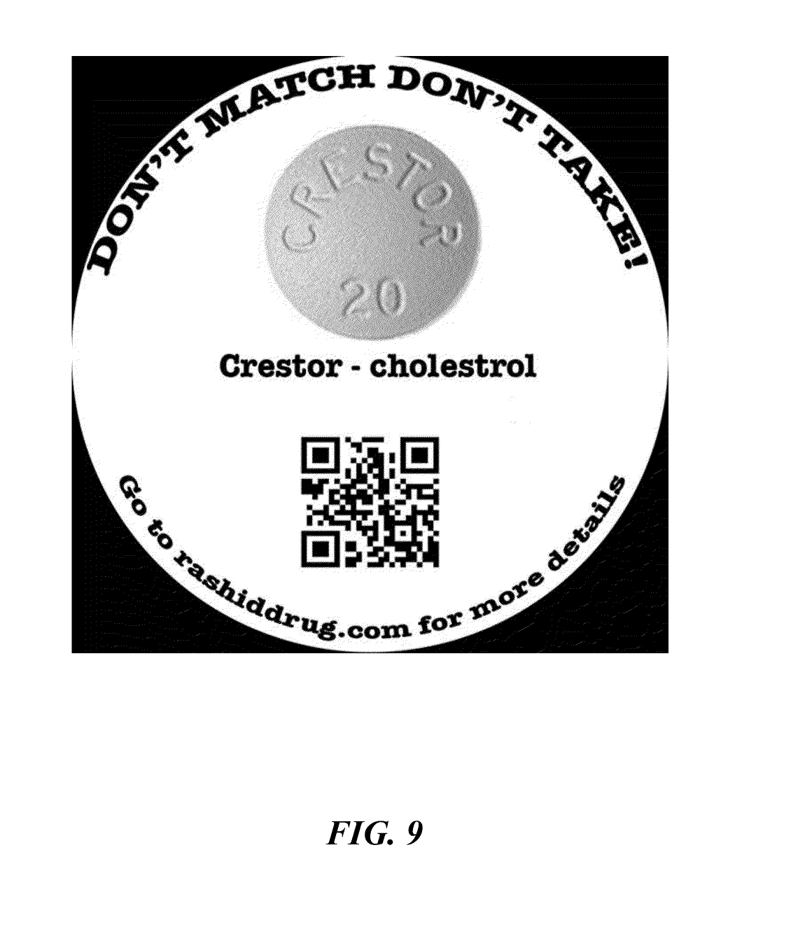

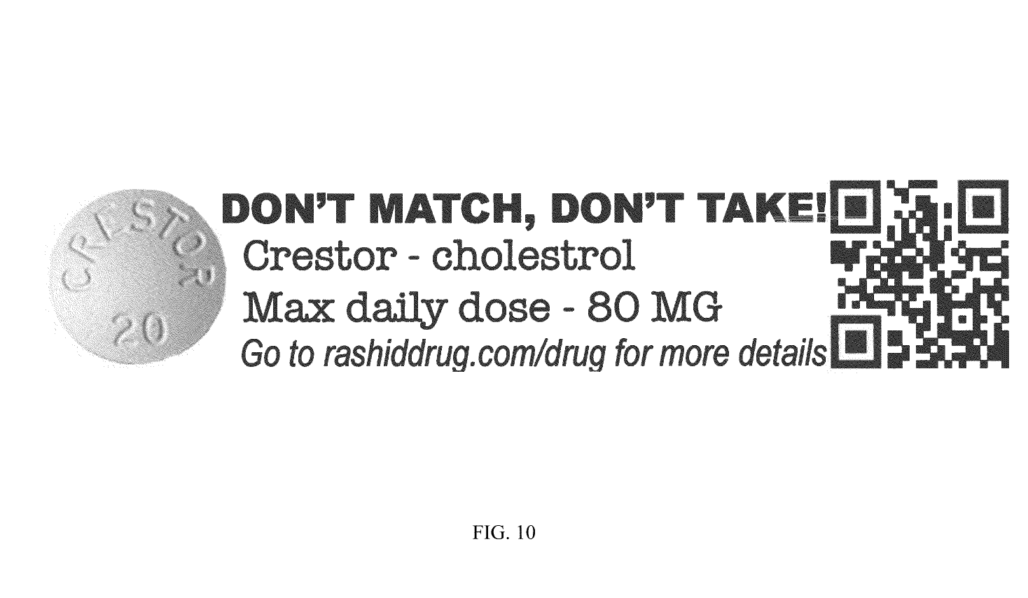

It should be noted that in practice, the step of verifying that the medication order has been accurately filled has traditionally involved a comparison of the contents of a stock container from which the dispensed medication was obtained to the contents of the container into which the ordered medication was disposed. In certain embodiments, the methods and systems disclosed herein may obviate the practice of referencing a stock container to confirm that the medication disposed in the container corresponds to the medication identified on the medication order. For example, the inclusion of a label comprising the relevant identifying information (e.g., a label as depicted in FIG. 4, FIG. 5, FIG. 6, FIG. 9 and FIG. 10) may be used in lieu of such stock containers to verify that the contents of the container correspond to the ordered medication. As a result, such stock containers may be immediately available to fill subsequent medication orders and thereby further improve the efficiency and productivity of pharmacy department personnel. Accordingly, in certain aspects the present inventions also relate to methods and systems useful for increasing or otherwise improving the productivity and efficiency of pharmacy department personnel.

In certain embodiments, the present invention also provides for one or more codes for retrieving a monograph corresponding to the ordered and/or dispensed medication. As used herein, the term “monograph” refers to detailed information regarding an ordered or dispensed medication's interactions, dosing, administration, classification, contraindications, adverse effects and other like information. Exemplary information that may generally be included on a monograph may comprise instructional or educational information about the ordered medication (e.g., what to do if the patient misses a dose), including the brand names, generic name, indications, dosage instructions, contraindications, storage instructions, potential adverse reactions, drug interactions and disease state interactions and combinations thereof. In certain embodiments, the monograph may be customized for a particular patient, for example, to communicate patient- or disease state-specific information to the patient. For example, such a patient-specific monograph may be customized such that information pertaining to a specific patient is provided or otherwise communicated in such monograph (e.g., information regarding potential drug-drug or drug-disease state interactions, information regarding compliance, or information regarding the availability of therapeutic alternatives or lower priced products).

The information communicated to patients by such monograph is frequently of a technical nature and is fundamental to a patient's proper understanding of the ordered medication and the administration thereof. While such monographs have been traditionally communicated to patients in a printed format, they are frequently discarded prior to having been reviewed by the patient. To the extent that such monographs are reviewed by the patient they are often promptly discarded soon after and as a result, subsequent inquiries regarding such medication are directed to pharmacy department personnel.

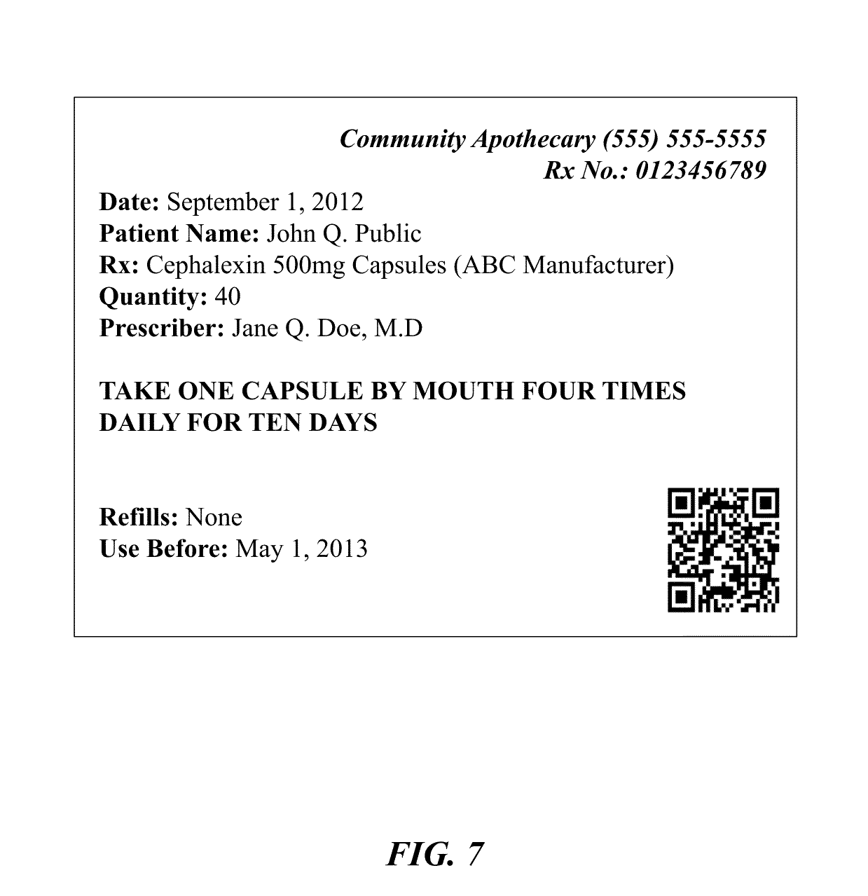

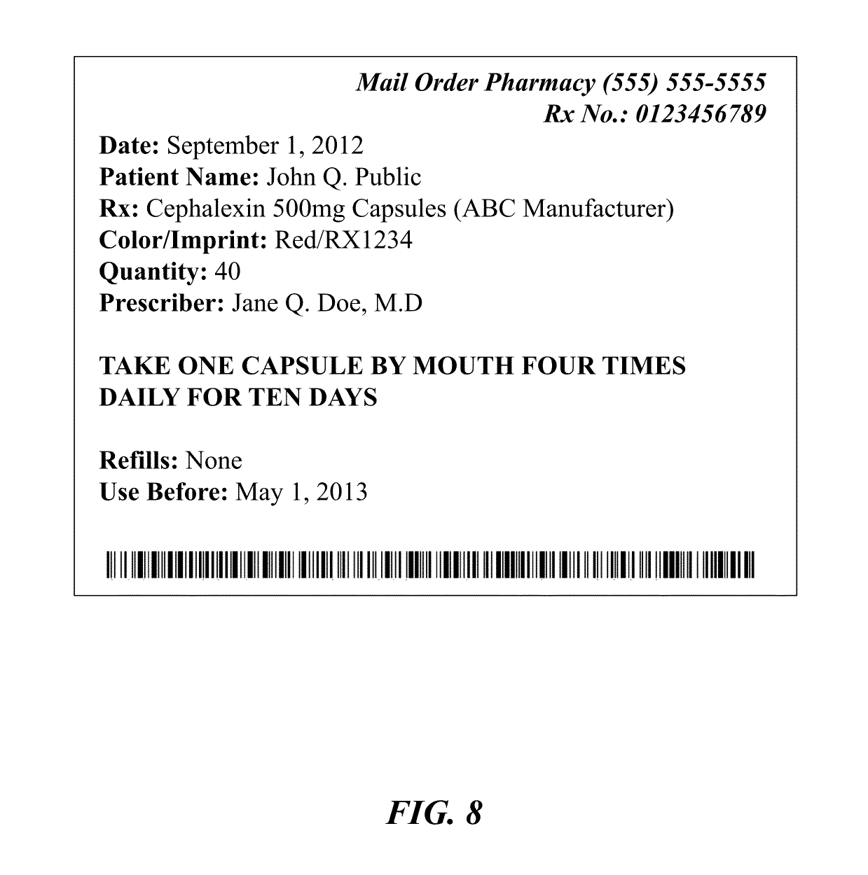

In certain embodiments of the present invention, the labels disclosed herein comprise a code for retrieving such monographs (e.g., by scanning a barcode with a mobile device). The term “code”, as such term relates to the retrieval of a monograph, refers to any means that may be used to retrieve a monograph. In certain embodiments, such codes facilitate the electronic retrieval and display of the monograph. For example, a barcode or QRCode may be included on one or more labels of the present invention and scanned to retrieve and display a monograph corresponding to the dispensed medication. In one embodiment, the code for retrieving the monograph comprises a bar code, for example as depicted in FIG. 8. In another embodiment, the code for retrieving the monograph comprises a QRCode, for example as depicted in FIG. 5, FIG. 7, FIG. 9 and FIG. 10. Similarly, in yet another embodiment, the code for retrieving the monograph comprises a phone number (e.g., a phone number directing the patient to an automated mailbox that provides such a monograph verbally). Still, in yet another embodiment, the code for retrieving the monograph comprises an internet address.

In certain embodiments, the label may comprise or consist of a code for retrieving a monograph corresponding to the ordered medication. The rapid and convenient availability and accessibility of a monograph (e.g., a customized monograph) reduces reliance on pharmacy department personnel to respond to routine questions and thereby increasing productivity and efficiency of pharmacy department personnel. As a result of reducing the dependency of such pharmacy department personnel to address routine questions, such personnel become available to perform other designated tasks or functions and thereby reduce the incidence or likelihood of medication errors (e.g., medication dispensing errors) and increase or otherwise improve the productivity and efficiency of such personnel.

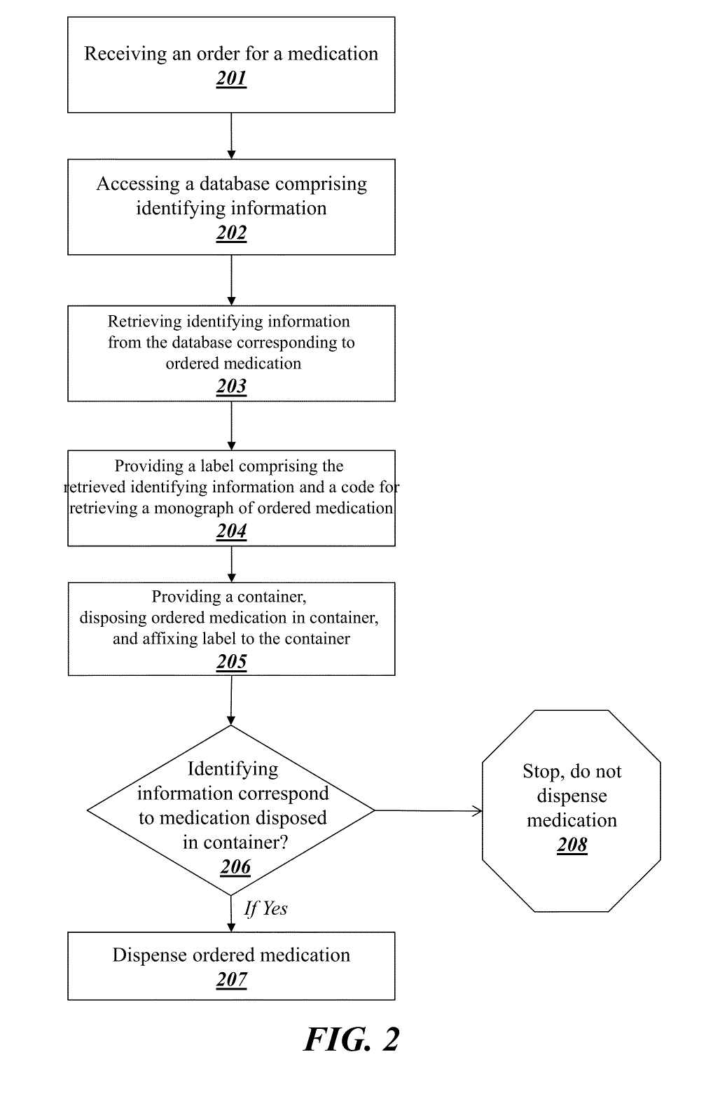

Certain embodiments of the present invention provide one or more codes to facilitate the retrieval and display of one or more monographs that correspond to the ordered or dispensed medication. For example, with reference to FIG. 2, in certain embodiments, the present inventions comprise a step of receiving a medication order (201), for example, a medication order or a medication refill request. Upon receipt of the medication order, a database comprising identifying information is accessed (202) (e.g., electronically accessed by pharmacy department personnel) and the record of the identifying information corresponding to the ordered medication is retrieved from the database (203) (e.g., electronically retrieved by pharmacy department personnel). Upon retrieval of the record of the identifying information corresponding to the ordered medication from the database, such identifying information (e.g., one or more of text and images) and a code for retrieving a monograph also corresponding to such ordered medication may be printed, published or otherwise written on a provided label (204) (e.g., a self-adhesive label). A suitable container may be provided capable of receiving the ordered medication, such ordered medication then being disposed in such container and the previously-provided label attached or affixed to such container (205).

Referring again to FIG. 2, the methods and systems disclosed herein may further comprise a step of determining whether the contents of the container (e.g., the medication disposed in the container) correspond with or otherwise resemble or match the identifying information present on the label affixed to such container (206). For example, after a medication order has been processed and filled by pharmacy personnel (e.g., a certified pharmacy technician), the medication order, the container containing the ordered medication and any other necessary information or documentation may be presented to a pharmacist to verify that such medication order was appropriately and accurately processed and filled. In certain embodiments, the medication disposed in the container is compared to the identifying information affixed to such container (206). If such medication corresponds to or otherwise matches the identifying information affixed to the container, the ordered medication has been accurately filled and may be dispensed (207) (e.g., dispensed to the patient). In those embodiments where the medication does not correspond to or otherwise match the identifying information affixed to the container, the ordered medication may not have been accurately processed or filled and the medication should not be dispensed (208). Rather, in such embodiments the incorrectly processed or filled medication should be subjected to further review, analysis or processing to correct or resolve the identified deficiency prior to being dispensed.

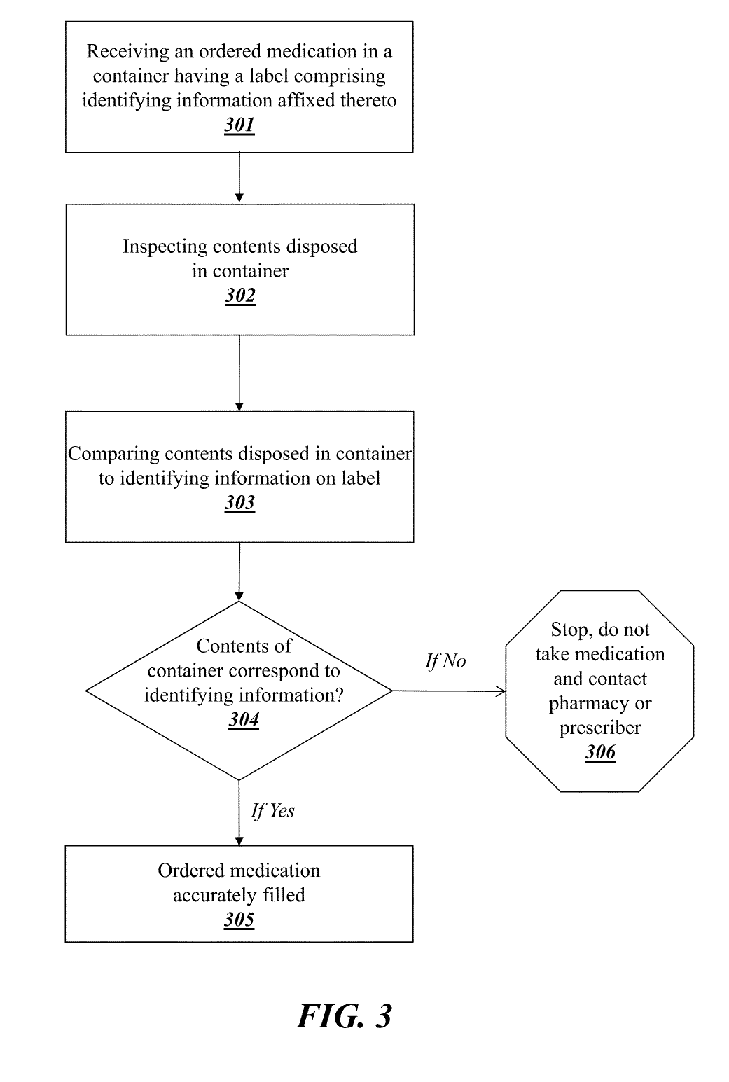

It should be understood that while the methods and systems disclosed herein may be used by pharmacy department personnel (e.g., a registered pharmacist) as a means of facilitating the determination that a medication order has been accurately filled, the utility of such methods and systems are not limited to pharmacy department personnel. For example, such methods and systems may be used by patients and their caregivers to determine or otherwise confirm that the ordered medication was accurately filled or dispensed. With reference to FIG. 3, in certain embodiments, the present inventions comprise a step of receiving a dispensed or ordered medication in a container having a label comprising identifying information affixed thereto (301). In certain embodiments, such a dispensed or ordered medication is received by the patient or their caregiver from pharmacy department personnel. Upon receipt of the ordered medication, the contents disposed into the container may be inspected (e.g., inspected by the patient) (302), such contents compared to the identifying information on the label (303) and a determination made as to whether the contents disposed in the container match or correspond to the identifying information on the label (304). For example, in those certain embodiments where the identifying information comprises a high-resolution color image of the ordered medication as illustrated in each of FIG. 4, FIG. 5, FIG. 6, FIG. 9 and FIG. 10, the contents disposed in the container may be visually inspected and compared to such identifying information. If such contents disposed in the container correspond to or otherwise match the identifying information affixed to the container, the ordered medication has been accurately filled (306). In those embodiments where the contents disposed in the container do not correspond to or otherwise match the identifying information affixed to the container, the ordered medication may not have been accurately filled and the medication should not be taken by the patient (307). Rather, the patient should contact the pharmacy and/or their prescriber (307). The rapid and convenient availability and accessibility of the identifying information (e.g., a high-resolution image corresponding to the ordered medication) reduces reliance on the pharmacist and pharmacy staff to respond to inquiries regarding the identity of dispensed medications. As a result, the productivity and efficiency of pharmacy department personnel may be increased and the likelihood of medication or dispensing errors thereby reduced.

The methods and systems disclosed herein generally involve steps of accessing one or more databases and the retrieval of information, codes and/or records from such databases. For example, such methods and systems may include a step of electronically retrieving information corresponding to the ordered medication from the accessed database using a computer. In certain embodiments, such database comprises a stored (e.g., physically or electronically stored) collection of records of identifying information and/or codes for retrieving a monograph. As used herein, the term “database” refers to one or more collections of information, works, data or other materials (e.g., identifying information and/or codes for retrieving a monograph). Preferably, such database is accessible (e.g., electronically accessible) by pharmacy personnel. In certain embodiments, the records of identifying information, codes for retrieving monographs, works, data or other materials that comprise the database are stored or otherwise maintained in electronic or digital form. In certain embodiments, the database comprises a plurality of records, wherein each record comprises identifying information and/or codes corresponding to a particular medication. For example, the database may comprise one or more records corresponding to a medication identified or otherwise organized by a National Drug Code (NDC) number, such that each NDC number is associated with at least one record. In certain embodiments, the database is updated periodically (e.g., on a daily, weekly or monthly basis).

In certain embodiments the database is a local database (e.g., physically located in or near the pharmacy department). For example, the database may comprise a memory device, such as an internal drive (e.g., a DVD, CD ROM, a hard drive, flash memory, a USB drive or the like) that may be located in or near the pharmacy department and accessed (e.g., electronically accessed using a computer) by pharmacy personnel. In certain embodiments, the database is a remote database (e.g., the database may reside on a remote server or drive and accessed electronically via a network or the Internet). The database may be configured to include individual records which may be retrieved by pharmacy department personnel. In certain embodiments, the database (e.g., a local database such as a hard drive or a USB drive) may be physically or electronically connected to a peripheral device such as a printer. In certain embodiments, the database is maintained by a third party.

In certain embodiments, the methods and systems disclosed herein comprise multiple databases (e.g., a first database, a second database and a third database). For example, a first database may comprise a series of records of identifying information corresponding to an ordered medication and a second database may comprise a series of records corresponding to codes for retrieving monographs corresponding to the ordered medication.

The identifying information, codes and/or records retrieved from the databases (e.g., retrieved from first database and a second database) may be disposed (e.g., printed) onto one or more labels. The labels disclosed herein may be affixed to the container and the contents of the container verified (e.g., by a pharmacist) to confirm whether or not the retrieved identifying information on such label corresponds to the ordered medication disposed in the container. In certain embodiments, if the retrieved identifying information on the label corresponds to the ordered medication disposed in the container, the medication order has been correctly filled. Conversely, if the medication disposed in the container does not correspond to the contents of the container, the medication order has been incorrectly filled.

In certain embodiments, the labels disclosed herein consist of identifying information. In certain other embodiments, the labels disclosed herein may further comprise additional information. For example, the labels (e.g., self-adhesive labels) may additionally comprise information selected from the group consisting of a patient's name, a patient's address, a prescriber's name, a name of the ordered medication, an expiration date of the ordered medication, number of refills remaining, a phone number and combinations thereof. In certain embodiments, at least two labels are affixed to the container. For example, a first label comprising the identifying information (e.g., the physical characteristics of the ordered medication and a code for retrieving a monograph) may be affixed to a container having a second label (e.g., a second label comprising the name of the patient, the name of the ordered medication and instructions for using such ordered medication).

The above-discussed and many other features and attendant advantages of the present invention will become better understood by reference to the following detailed description of the invention when taken in conjunction with the accompanying examples. The various embodiments described herein are complimentary and can be combined or used together in a manner understood by the skilled person in view of the teachings contained herein.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one or the entire group members are present in, employed in or otherwise relevant to a given product or process. Furthermore, it is to be understood that the invention encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise. Where elements are presented as lists, (e.g., in Markush group or similar format) it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. The publications, websites and other reference materials referenced herein to describe the background of the invention and to provide additional detail regarding its practice are hereby incorporated by reference.

### EXAMPLES

### Example 1

The methods and systems disclosed herein may be readily implemented by a pharmacy department (e.g., a community or hospital pharmacy) to improve the productivity and efficiency of pharmacy department personnel and thereby reduce the incidence of medication and dispensing errors. A peripheral device such as a hard drive or printer may be configured with or connected to one or more databases comprising records of identifying information which may be accessed by pharmacy department personnel and the record corresponding to an ordered medication retrieved. The retrieved identifying information corresponding to the ordered medication (e.g., a high-resolution image of the ordered medication) may be printed or otherwise disposed onto a provided label and affixed to the container into which the ordered medication has been disposed.

The use of one or more labels, such as those depicted in FIG. 4, FIG. 5 and FIG. 6, may be used as a means of facilitating the verification process and thereby reduce the incidence of medication dispensing errors. Furthermore, such labels obviate the traditional practice of delivering one or more stock containers from which the medication order was filled to the verifying pharmacist as a step in the verification process or protocol. As a result, such stock bottles may be readily available to fill subsequent medication orders and thereby reduce the extent to which such additional medication orders are delayed awaiting the return of the stock bottles. Additionally, once the ordered medication has been verified and dispensed, the patient or a caregiver may easily compare the dispensed medication to the identifying information on the label to confirm that such medication has been accurately dispensed.

### Example 2

The methods and systems disclosed herein may be readily implemented by a pharmacy department (e.g., a retail, hospital or mail order pharmacy department) to improve productivity and efficiency of pharmacy department personnel and thereby reduce the incidence of medication and dispensing errors. In particular, the accessing and retrieval of one or more codes (e.g., a barcode) for retrieving a monograph corresponding to the ordered medication from one or more databases and the inclusion of such codes on one or more labels affixed to a container into which an ordered medication has been disposed may be easily incorporated into a pharmacy department's existing practices and protocols.

The availability of one or more labels comprising such codes for retrieving monographs corresponding to the ordered medication, such as those depicted in FIG. 5, FIG. 7, FIG. 8, FIG. 9 or FIG. 10, may be used as a means of rapidly and conveniently making such monographs available to a patient and their caregivers. Such monographs contain important information that may not have been effectively communicated to the patient. For example, those patients that may not have had an opportunity to be counseled by the pharmacy department personnel (e.g., mail order pharmacy patients) increasingly rely on such information and the convenient and rapid availability, retrieval and display of the applicable monograph is of particular importance to such patients. In particular, such codes (e.g., a QRCode) may be used by a patient or their caregivers to access (e.g., electronically access using a scanner, mobile phone, computer or other similar device) and display (e.g., on a mobile phone, computer or similar device) the monograph corresponding to the ordered medication. Such monographs are therefore readily available and accessible by the patient and their caregivers at any time and are unlikely to be discarded or inadvertently lost, as is often the case for traditional printed monographs.

Such methods and systems further provide means of rapidly and conveniently communicating information to patients and their caregivers regarding the proper use and administration of an ordered medication. Furthermore, it is expected that the inclusion of such labels comprising a code for retrieving a monograph corresponding to the ordered medication will reduce the reliance on pharmacy department personnel to receive and respond to routine questions and inquiries regarding such ordered medication, and as a result thereby improve the productivity and efficiency of pharmacy department personnel and reduce the incidence of medication errors and in particular those errors due in part to improper administration and use of an ordered medication. Additionally, the use of such codes may obviate the provision of printed monographs to a patient and thereby reduce or eliminate the need to print or otherwise provide such printed monographs to patients.

The methods and systems disclosed herein may therefore be used to improve the efficiency and productivity of pharmacy departments and their personnel, and in particular to improve the efficiency and productivity of such personnel involved in the preparation and/or dispensing of ordered medications. Furthermore, the present inventions are capable of reducing the incidence of medication dispensing errors and adverse reactions associated with the improper use or administration of medications.

What is claimed is:

1. A method of dispensing a medication, such method comprising the steps of:
receiving an order for the medication;
accessing a database, wherein the database comprises identifying information;
retrieving the identifying information from the database, wherein the retrieved identifying information corresponds to the ordered medication;
providing a label, wherein the label comprises the retrieved identifying information;
providing a container, wherein the container is suitable to receive the ordered medication;
providing the ordered medication, wherein the ordered medication is disposed in the container;
affixing the label to the container; and
comparing the retrieved identifying information on the label to the medication in the container, wherein if the retrieved identifying information on the label corresponds to the ordered medication disposed in the container, the ordered medication may be dispensed.

2. The method of claim 1, wherein the label further comprises a code for retrieving a monograph corresponding to the ordered medication.

3. The method of claim 2, wherein the monograph is retrieved from a website.

4. The method of claim 2, wherein the code for retrieving the monograph comprises one or more of a bar code, a QRCode, a phone number and an internet address.

5. The method of claim 1, wherein the retrieved identifying information comprises an image.

6. The method of claim 1, wherein the retrieved identifying information comprises a National Drug Code (NDC) number.

7. The method of claim 1, wherein the retrieved identifying information further comprises one or more identifiers of the ordered medication, wherein the identifiers are selected from the group consisting of size, shape, color, markings, dosage form and combinations thereof.

8. The method of claim 1, wherein the label further comprises information selected from the group consisting of a patient's name, a patient's address, a prescriber's name, a name of the ordered medication, an expiration date of the ordered medication, number of refills remaining, a phone number and combinations thereof.

9. The method of claim 1, wherein the method reduces the incidence of medication dispensing errors.

10. The method of claim 1, wherein the method improves medication dispensing efficiency.

11. A system for verifying that a medication order has been correctly filled, the system comprising the steps of:
receiving an order for the medication;
accessing a database, wherein the database comprises identifying information;
retrieving the identifying information from the database, wherein the retrieved identifying information corresponds to the ordered medication;
providing a label, wherein the label comprises the retrieved identifying information, and wherein the label further comprises a code for retrieving a monograph corresponding to the ordered medication;
providing a container, wherein the container is suitable to receive the ordered medication;
providing the ordered medication, wherein the ordered medication is disposed in the container;
affixing the label to the container; and
verifying the contents of the container, wherein the verifying step comprises comparing the retrieved identifying information on the label to the ordered medication disposed in the container, and wherein if the retrieved identifying information on the label corresponds to the ordered medication disposed in the container, the medication order has been correctly filled.

12. The system of claim 11, wherein the retrieved identifying information further comprises one or more identifiers of the ordered medication, wherein the identifiers are selected from the group consisting of size, shape, color, markings, dosage form and combinations thereof.

13. The system of claim 11 wherein the monograph is retrieved from a website.

14. The system of claim 11, wherein the code for retrieving the monograph is selected from the group consisting of a bar code, a QRCode, a phone number and an internet address.

15. The system of claim 11, wherein the retrieved identifying information comprises an image.

16. The system of claim 11, wherein the retrieved identifying information comprises a National Drug Code (NDC) number.

17. The system of claim 11, wherein the retrieved identifying information further comprises one or more identifiers of the ordered medication, wherein the identifiers are selected from the group consisting of size, shape, color, markings, dosage form and combinations thereof.

18. The system of claim 11, wherein the label further comprises information selected from the group consisting of a patient's name, a patient's address, a prescriber's name, a name of the ordered medication, an expiration date of the ordered medication, number of refills remaining, a phone number and combinations thereof.

19. The system of claim 11, wherein the system reduces the incidence of medication dispensing errors.

20. The system of claim 11, wherein the system improves medication dispensing efficiency.
